(19) United States
(12) Patent Application Publication
(10) Pub. No.: US 2025/0299122 A1
(43) Pub. Date: Sep. 25, 2025

(54) INTELLIGENT SYSTEM FOR VISUAL MEDIA

(71) Applicant: ZUMEDIA INC., New York, NY (US)

(72) Inventors: Phyllis Jager, New York, NY (US); Barry Terach, Goshen, NY (US); Mark Cuban, Dallas, TX (US)

(21) Appl. No.: 19/084,648

(22) Filed: Mar. 19, 2025

Related U.S. Application Data
(60) Provisional application No. 63/567,084, filed on Mar. 19, 2024.

(51) Int. Cl. G06Q 10/0631

(52) U.S. Cl. CPC G06Q 10/063112

(57) ABSTRACT

The technology disclosed herein is an electronic device comprising one or more processors, one or memories, and one or more programs. The one or more programs are stored in the memory and configured to be executed by the one or more processors. The one or more programs includes instructions for receiving, within a communication session between a user and a system program, a user request for the system program to facilitate the use of an industry function using an industry program.

### CROSS-REFERENCE TO RELATED APPLICATION

This application claims the benefit of U.S. Provisional Application No. 63/567,084, filed Mar. 19, 2024, entitled, “Systems and Platform for Film Making,” the entirety of which is incorporated herein by reference.

### BACKGROUND

The use of technology in the film making ecosystem has been transformative. Over time there have been dramatic changes in how films are made, the technology that is employed, and the economics involved within the production process. Today, industry insiders no longer have a monopoly on the production, distribution, and marketing of films. Technology has made access easier and more distributed. The people involved at all levels have more control over their careers and visions.

The technology disclosed herein provides creators a vehicle to manifest their inspirations into published motion picture content. The technology can place a movie studio in the palm of the hand of the artists via a smart phone. With the technology, a filmmaker can produce a professional quality movie, series, short subject, or any other visual media using just a smart phone. The technology platform and system can be used to create, manage, market, and distribute visual media using dynamic databases, processors, and streaming technology.

### SUMMARY

For a technology system to replace or support an entire industrial, creative, ecosystem such as the movie industry, TV industry, or visual content creation generally, it must be able to support and interact with many levels of technology acumen and perform a large number of processes. Each role in a complicated ecosystem such as the movie industry has its own multitude of tools, software, platforms, and business methods. Each requiring specific knowledge of functionality and execution. Interfaces, functions, performance, and options might all be different from tool to tool, software to software. This makes it impossible for a single person or even a few people to execute a movie that coincides closely with a creative vision in this industry. While the resources available to make visual content are vast, the expertise and knowledge required makes it difficult to do without a studio or other large infrastructure to support it.

The various embodiments of the present technology provide automated and intelligent assistance to a user that integrates software capabilities and devices. Multiple interfaces and functionality are provided for different users. The embodiments provide different operations and functionality for each user class including, e.g., actors, producers, directors, sound, lighting, distribution, marketing). The user classes can be used by one user instance or multiple user instances on the same account. The user can also mix and match in a dynamic operation and in real-time the operations and functions they require to execute their role. The intelligent systems of the present technology can perform any or all of: actively eliciting input from a user, interpreting user intent, disambiguating among competing interpretations, requesting and receiving clarifying information as needed, and performing (or initiating) actions based on the discerned intent of the user. The user therefore does not need expertise in all areas of these industries to be able to create visual content and products in these industries.

According to various embodiments of the present technology, an intelligent automated system is implemented on an electronic device, to facilitate user interaction with the device, and to help the user more effectively engage with the multitude of industry services in real-time. In various embodiments, the intelligent automated system engages with the user in an integrated, conversational manner using natural language dialog, and invokes external services when appropriate to obtain information or perform various actions.

The industries referred to herein include the movie and film industry, television, and certain social media all dealing with visual moving content.

### BRIEF DESCRIPTION OF THE FIGURES

FIG. 1 is an example of a technology system program for onboarding users as disclosed herein.

FIGS. 2-4 are examples of a technology system program for movie studio tools as disclosed herein.

FIGS. 5-6 are examples of a technology system program for coordinating tasks involved in motion picture content creation as disclosed herein.

FIGS. 7-8 are examples of a technology system program for users to pitch content ideas to other users as disclosed herein.

FIGS. 9-10 are examples of a technology system program for users to exchange money or other value to other users as disclosed herein.

FIGS. 11-13 are examples of a technology system program for users to market and advertise content to other users as disclosed herein.

FIGS. 14-15 are examples of a technology system program for users to create and modify an account that includes and influences user values as calculated by the technology disclosed herein.

FIG. 16 is an example of a technology system program for users to watch content as disclosed herein.

FIG. 17 is an example of a technology system program for setting and changing settings for production, editing, and user accounts that includes and influences user values as calculated by the technology disclosed herein.

FIG. 18 is an example of a technology systems program for casting actors as disclosed herein.

FIG. 19-20 are examples of a technology system program for users to message other users that includes and influences user values as calculated by the technology disclosed herein.

FIG. 21 is an example of a technology systems program for a marketplace of goods and services to be exchanged by users as disclosed herein.

### DETAILED DESCRIPTION

The technology disclosed herein is an electronic device comprising one or more processors, one or memories, and one or more programs. The one or more programs are stored in the memory and configured to be executed by the one or more processors. The one or more programs includes instructions for receiving, within a communication session between a user and a system program, a user request for the system program to facilitate the use of an industry function using an industry program.

In response to receiving the user request for the system program to facilitate the use of the industry function using an industry program, the technology determines one or more user values. The user values can be based on different user characteristics including: the user's past roles in the industry; the user's identification of a role; the user's expertise within this role; the user's financial commitment to the technology; the user's tastes and preferences; content within a user's messages; how a user uses an industry program or system program; or, the user's abilities as determined from the user's input, the user's past use, or other users' feedback.

Also in response to receiving the user request for the system program to facilitate the use of the industry function using an industry program, the technology can facilitate the use of the industry function using an industry program by: identifying one or more industry programs that provides the industry function requested by the user; determining one or more values for the one or more identified industry programs; and, matching the best valued industry programs with the user by choosing the closet values for each of the users and industry programs.

The technology can transmit the industry program to the electronic device where the user can be provided access to the program. The user can respond to the transmission by indicating approval or disapproval of the match.

In one embodiment, the technology is based on sets of interrelated domains and tasks, and employs additional functionally powered by external services with which the technology can interact. The industry programs can be accessed by, e.g., activating any industry programs that are available on an electronic device, or industry programs that are available over an electronic network such as the Internet. In various embodiments, activation of external programs can be performed via APIs or by any other suitable mechanism. The industry programs can include software that allows industry functions, e.g. the recording of images or sounds, programs that provide the control or counsel on lighting or camera choices and angles; programs that provide means for distributing content or stream content, programs for finding industry professionals, programs for finding industry roles, and any other program that is used or useful in the industry. E.g., industry programs can be a production studio with tools to create and produce films. Filmmakers can also purchase production tools to create their project.

The users are people or artificial intelligences that play any role within the industry. These include, e.g., actors, directors producers, writers, cinematographers, animators, special effects professionals, editors, sound professionals, lighting professionals, and set designers, costume professionals, audiences, and others.

Economic instances can be incorporated into the technology, e.g. users can pay fees for access or use of the technology. These fees can differ based on the amount of use of the technology (e.g. by megabyte), or the amount of time the technology is used. Some content can be free, some as a pay per view rental, and there can be subscriptions for specific content.

The technology also can have a marketplace where filmmakers can choose from a library database of music, sound effects, graphics, etc., to add to their production. These can be free to use or available for purchase, and royalties can go to the artists that produced them.

Filmmakers can also use a collaboration feature to collaborate on a project with other artists, musicians, producers, screenwriters, actors, etc. from around the world. The technology can allow the income derived from the collaborated project to be divided up as agreed to by the party's involved.

Filming can be done using anything from a smart phone to a professional digital movie camera. The filmed content can be refined into a finished product using studio tools programs to edit, add graphics, CGI effects, music, Green Screen effect, sound effects and more.

The technology can also automatically build a database of sound effects to capture the perfect sound for any scene. All film productions can be distributed through the technology with its compression software allowing for a vast database with little to no buffering. Any film on the database can be made available worldwide on the platform.

With the collaboration feature, people can collaborate from around the world without having to travel. Connections can be made by the technology with talent anywhere in the world with a digital interface. The technology allows a director and cinematographer to shoot a scene on location in, e.g. India, while sitting in an office in Atlanta Ga. In addition, the technology provides a venue to distribute visual content.

The technology allows for users to upload information to the memories for access by users. E.g., anyone with an idea for a project to pitch their idea to people that may be interested in producing the film for them. By uploading either a video or pitch material, potential investors or producers can review and possibly purchase the rights to the project.

The technology can also provide a round-bale program that e.g., provides a user an area to recruit talent, share ideas, sign contracts, complete tasks within the production, track the progress of the project, and overall manage the film production from start to finish.

The technology can provide a marketplace program that provides a user an instance where users can shop for anything from a piece of equipment to sound effects or music, to search for cast or crew, or for screenwriters to sell their screenplays.

When the film is ready for distribution, the finished product can be uploaded to the viewer database on a memory for the public to purchase, e.g. on a pay-per-view (48 hour) basis. Using the search function provided by a processor, a user can search for a movie to watch with filters such as genre, run-time, keywords, and geographic region. A user producer can sell advertising on their project in the form of previews and overlay ads. They can also purchase space on another film to air a preview of their own for better exposure. All revenue generated on the production whether from sales and advertising can be shared and distributed on the technology. A user producer can also have a say where the film can be distributed based on the target market they want to reach. E.G., the technology can create seven distinct geographic regions for distribution and advertising. Also, users that find a film to be interesting, can “tip” the producer, or director or even an actor using a system program virtual wallet on the technology.

When entering the user interface provided by the technology the user can pass through a splash screen to a landing page. At the landing page a series of trailers can be running in a loop. The user can have the option to view the entire trailer. A user can click on a series of characteristics to identify themselves, e.g. experience level, type of user, type of project, type of content they like or don't like, musical preferences for genre, styles, moods, tempo, and many other characteristics.

The technology also provides options to assist in ease of navigation. There can be a search wheel that can direct the user to the search page as well as specific options for, e.g., the marketplace, the novice or experts instances, and the pitch portal.

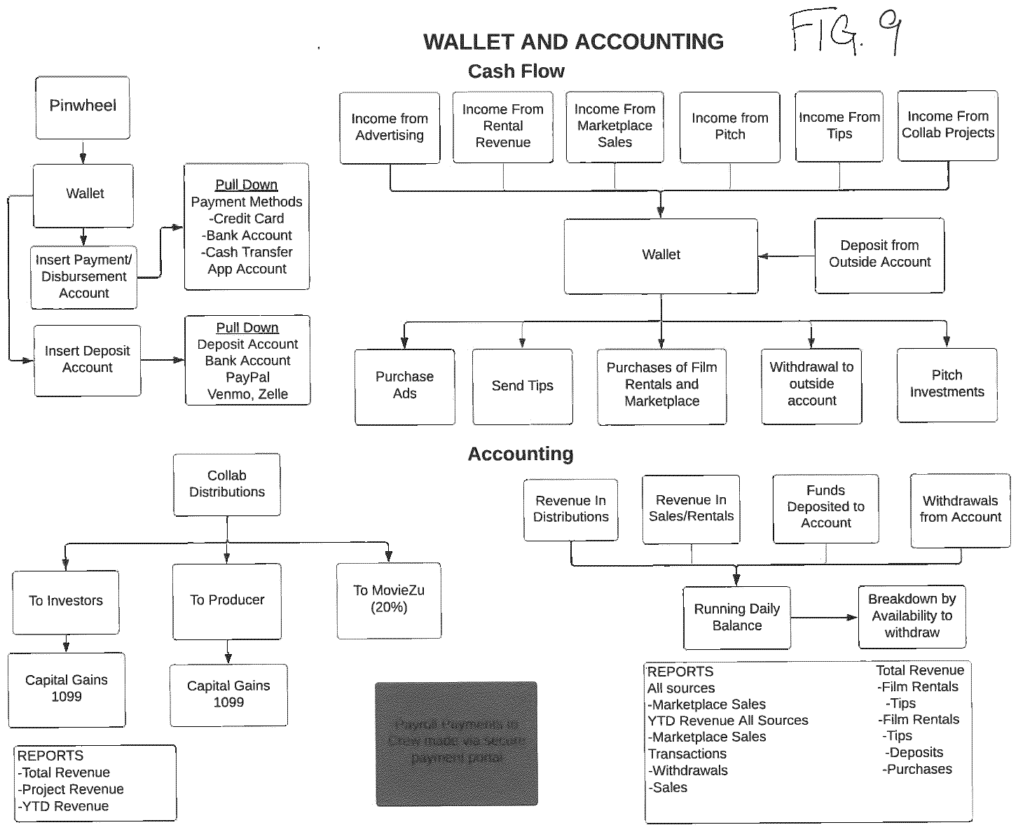

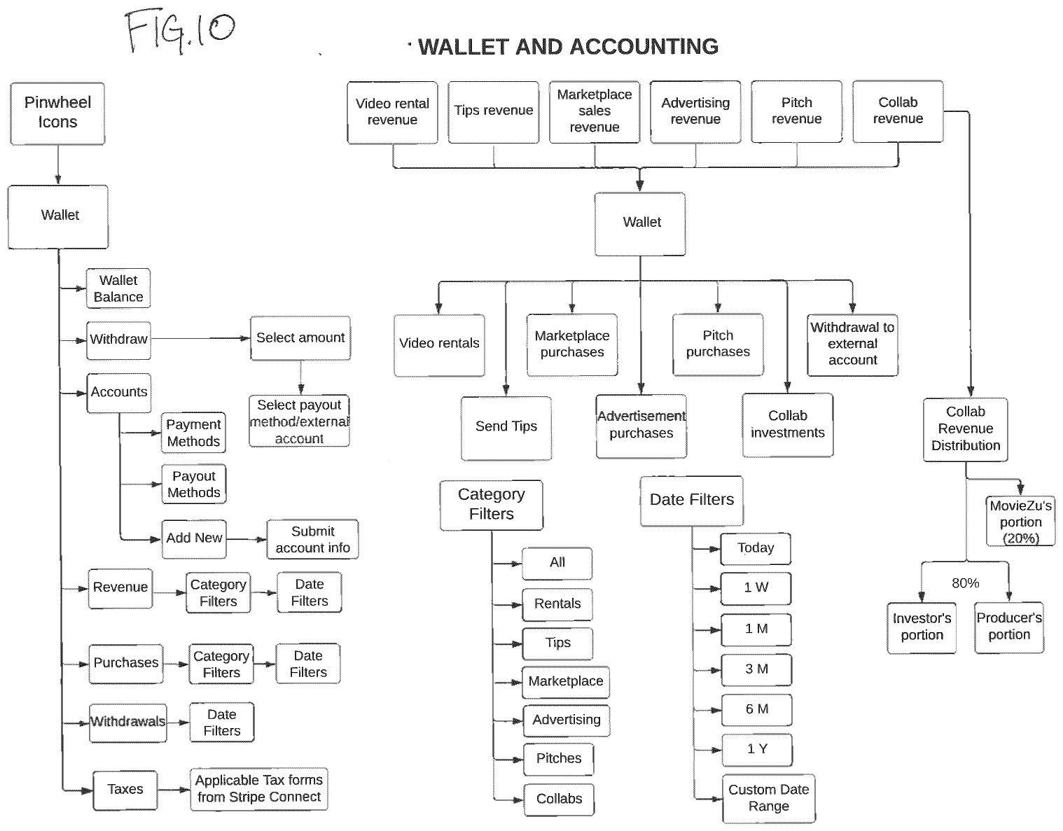

In order to make a purchase the user can create a profile and provide a method of payment. The wallet is a secure place to store sensitive financial information by the technology, e.g. FIGS. 9-10.

When content is chosen and purchased, it is downloaded or streamed to the users device for viewing.

All content in the memories have viewing recommendations. These can be posted as follows:
CA—Content Advisory—the film may contain elements that may not be appropriate for all audiences such as nudity, violence, sexual contact, adult themes, strong language.
WA—Wide Audience—This film is appropriate for audiences of any age.
AA—Adult Audience—This film is not appropriate for audiences under 18. (will usually be accompanied by CA)
YA—Young Audience—This film is intended for audiences between the ages of 12 and 18.
TA—Tender Audiences—This film is intended for children under 12.

There is also the option of setting parental controls to limit access to certain content.

User viewer can review the content can also follow specific artists.

Content on the database can have previews that run prior to the start of the chosen content. Depending on the run time of the content, there can be one or more previews shown. Additionally, there can be a series of overlay ad spaces available that can show at areas of the screen during the previews or play of the chosen content. The placement of these ads can be designed to not interfere with the viewing of the film and take away from the viewer experience.

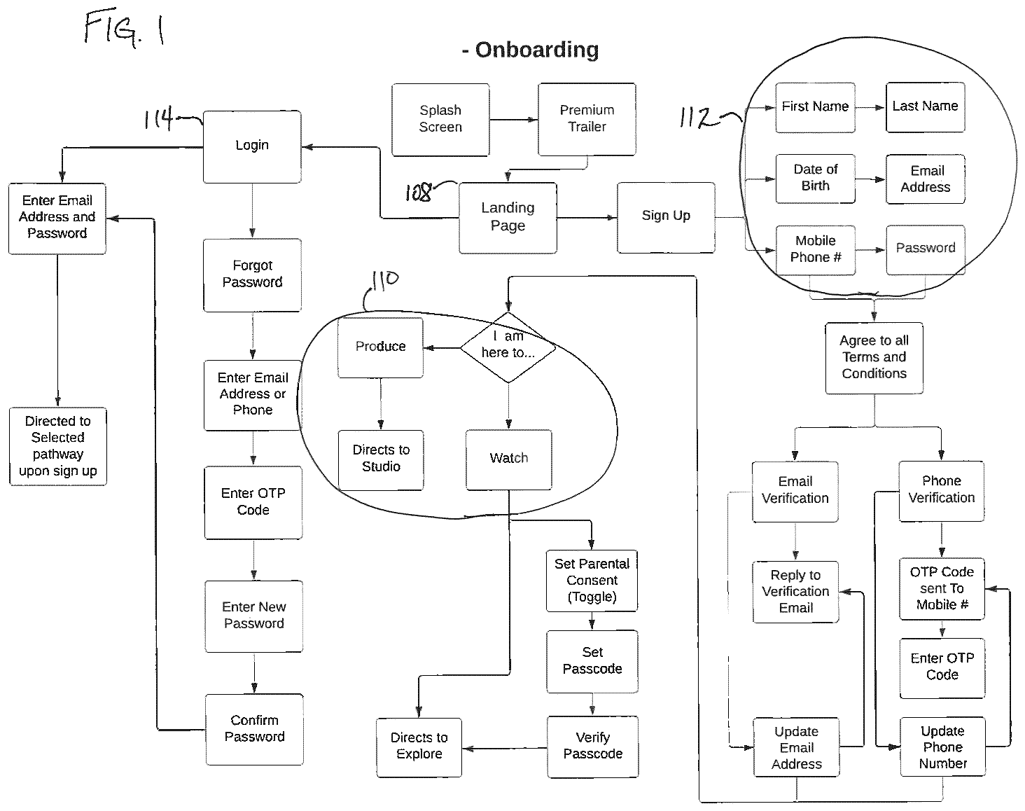

An example of an onboarding system program is shown in FIG. 1. From the landing page 108, users can provide the technology with background information about themselves to create a profile 112 that may be comprehensive or not. Login credentials 114 can be entered to provide access to the user account. Once on the profile page 112 a user can create an account profile as a viewer, and additional fields can appear that can describe content making roles. Whether as a producer, actor, director, investor, or any other industry job title can be available in a pull down bar 110.

Once a user profile is created, e.g., for a producer, the “Producer” can start a project by uploading a content file to the system Studio program. The studio program could be proprietary to the technology or a third-party application. The technology can offer the producer a choice of studio applications available based on the technology determined users values and studio program values.

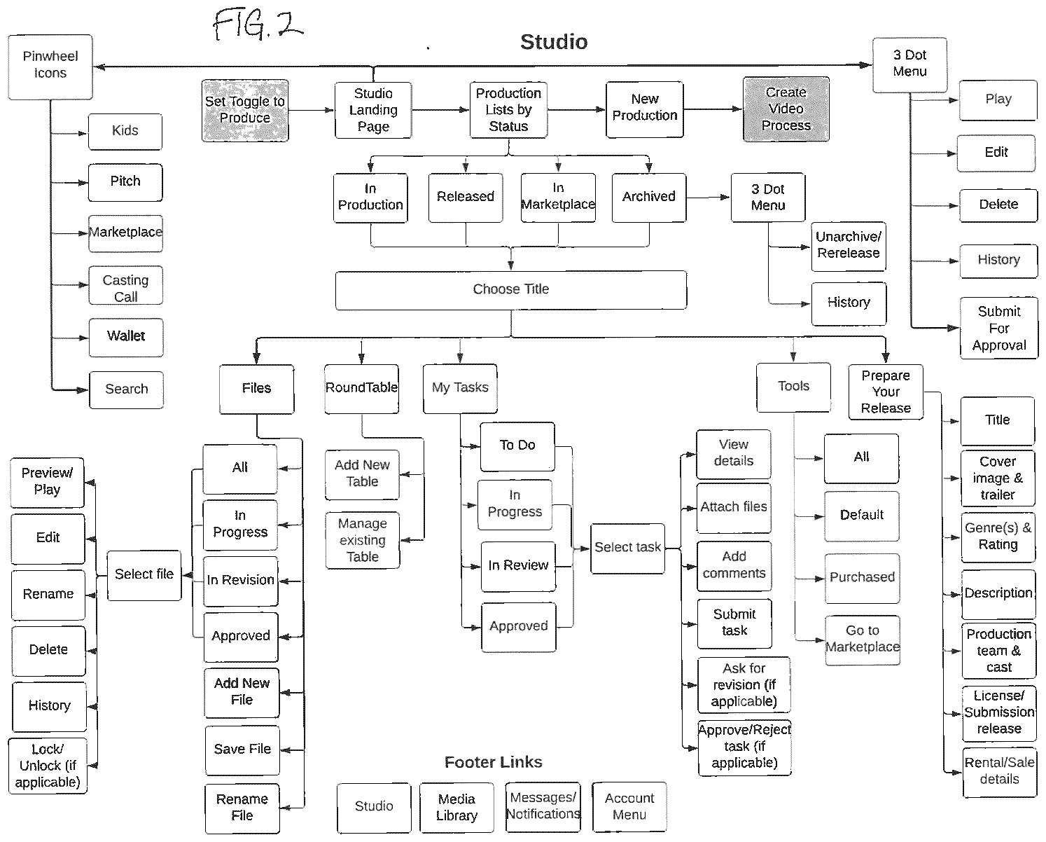

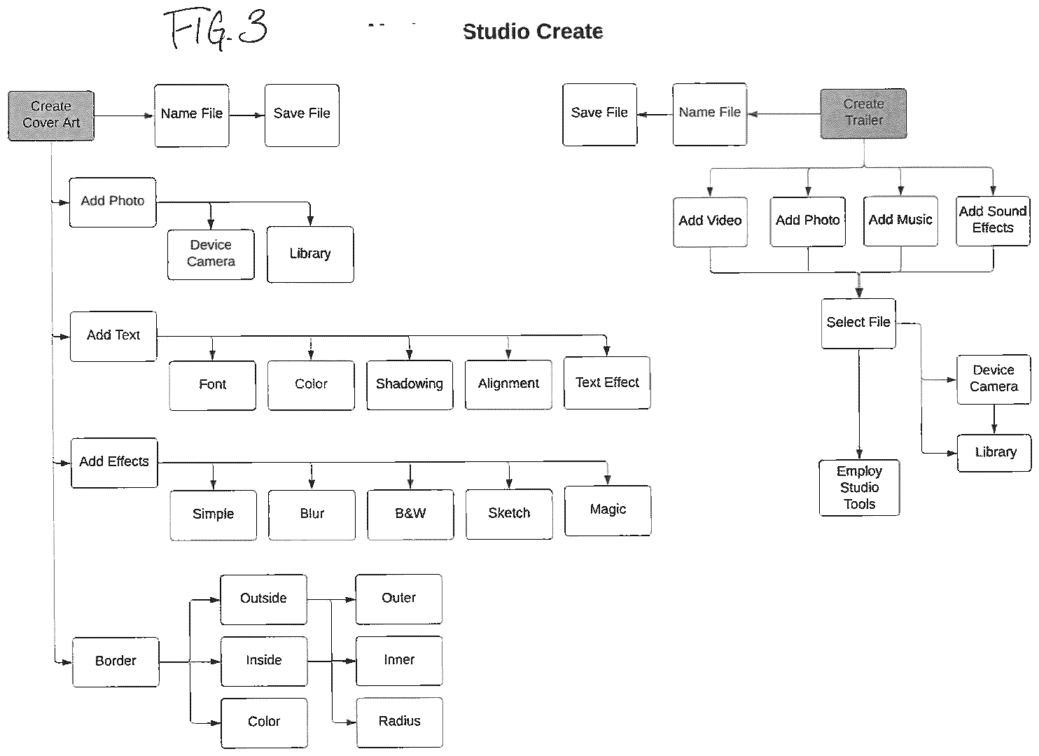

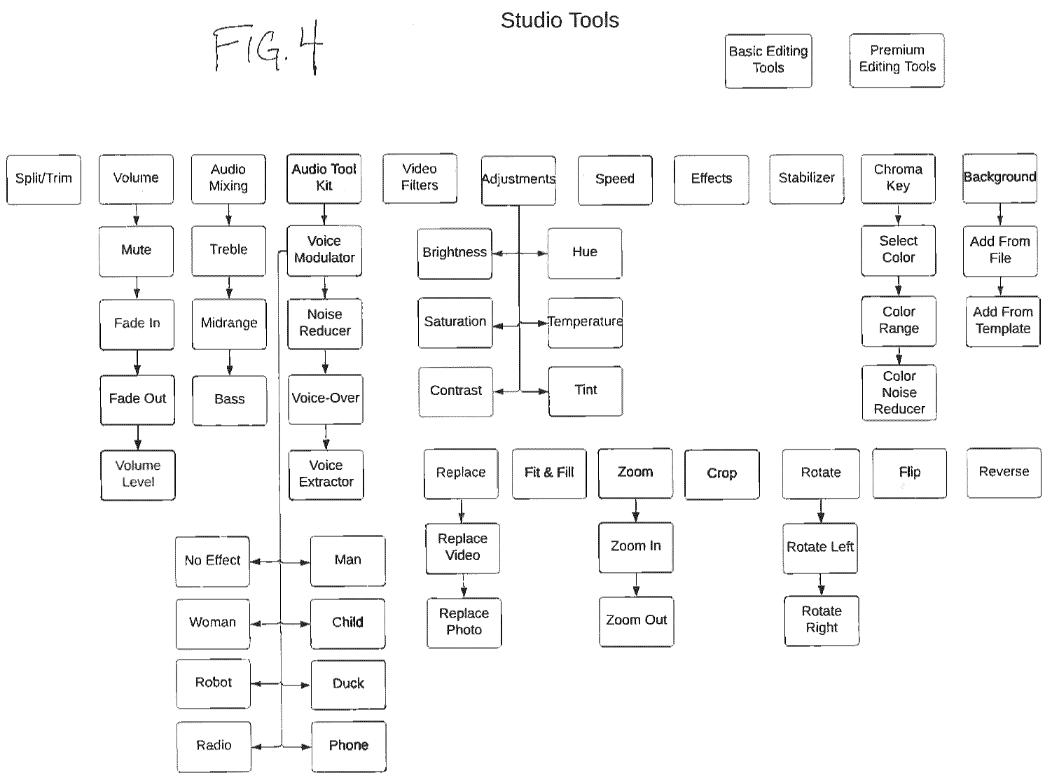

User values can be automatically and substantially continuously derived by the technology based on the user profile and user interactions with the technology. For a novice producer user, new to the technology, the values will be on one side of the value scale. For an expert producer user that has greatly interacted with the technology, the user values will be on the opposite end of the value scale. The scale remains substantially constant but the users value can change based on use or gained experience or knowledge. The program values are derived by the technology based on the complexity of the program, reviews of the program by users or others, and other known variables. A complex program with robust and difficult functionality that requires certain expertise to use will be at one side of the program value scale. A program that is simple and intuitive to use with less functions will be on the other side of the scale. These program values can change based on, e.g., program updates or user reviews. FIGS. 2-4 show a sample studio program available for the applicable user. The technology monitors the uses of the system programs and industry programs to assign and update user values on a continuous basis. “Continuous” means herein every microsecond up to monthly, or from every hour to once a day, or other possible ranges of time.

Other system programs and third-party programs for creating content can be provided by the technology, all of which can have technology applied values for matching with users purposes. These include Special Effects, Music, Sound Effects. Equipment can also be purchased in the Marketplace system program. Talent can be found in the Marketplace in the form of screenwriters, composers, actors, directors, and any other crew members can post themselves on the Marketplace. A producer can also send out a casting call through the Marketplace. Items in the marketplace can also be auctioned off to the highest bidder.

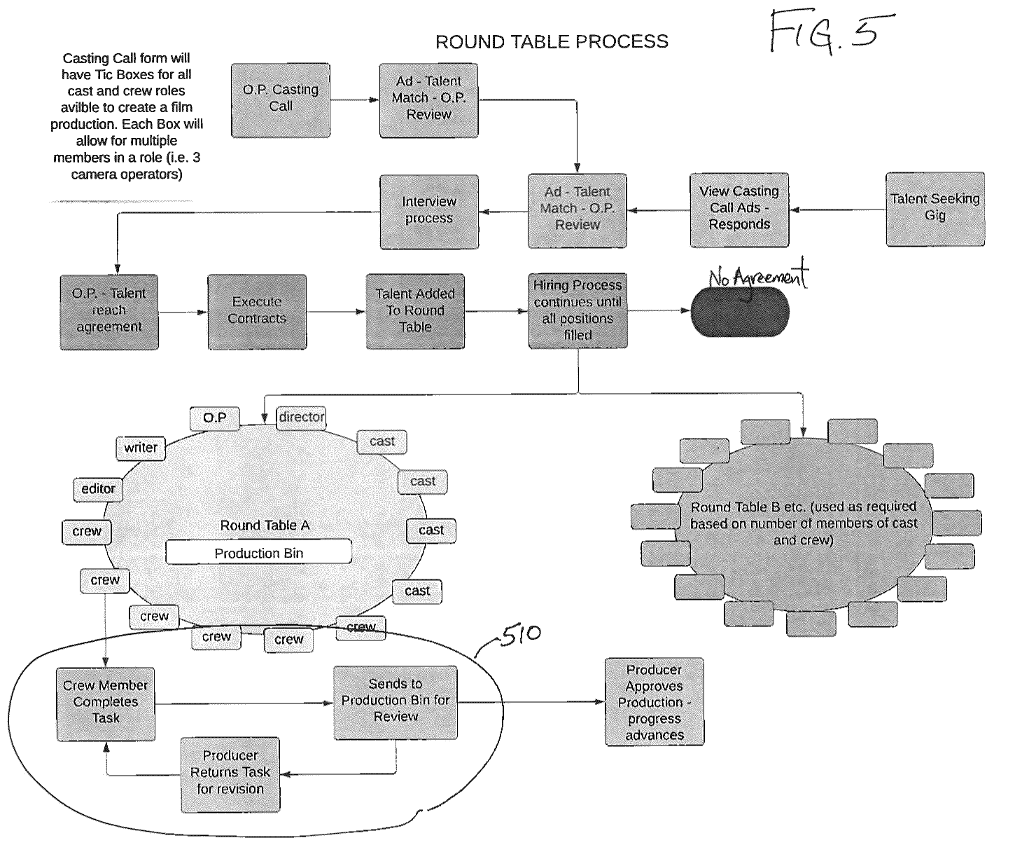

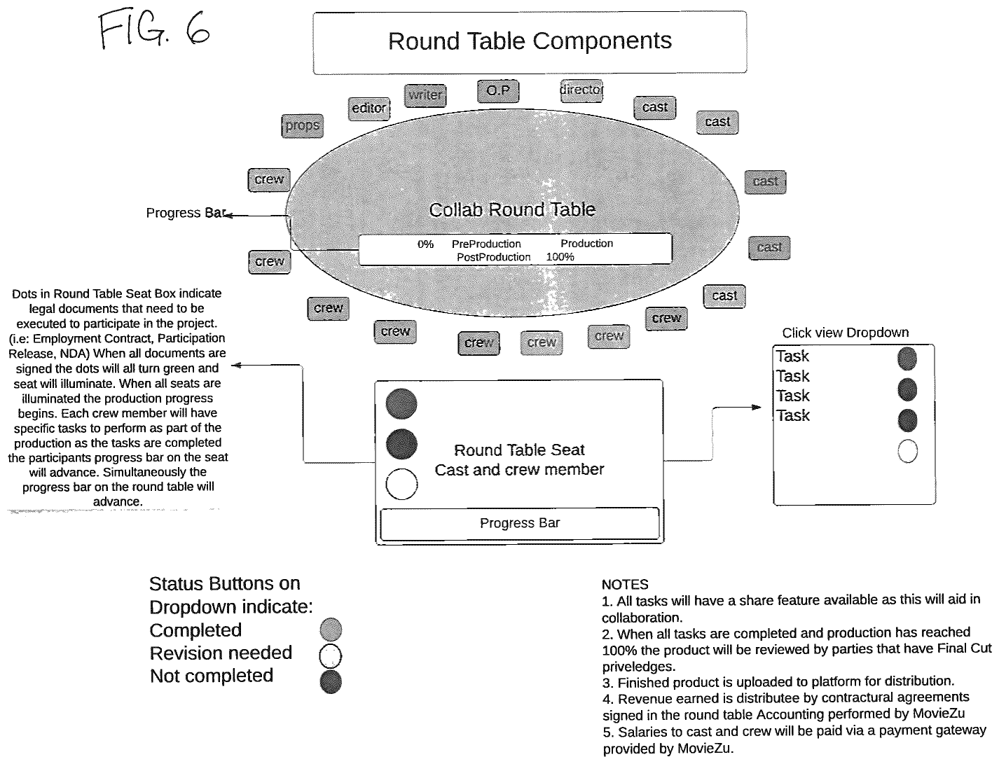

A producer can also use a system Collaboration program to build a cast and crew for a project as well as actually collaborate on the project using the system program Round Table, FIGS. 5-6, a virtual conference table that is also a project management tool. This feature allows the producer to, e.g., create the crew, sign contracts, assign tasks and monitor progress. Within the Round Table can be a Bin which is a place to send completed task files to the producer for review and approval. E.g., 510 can represent a writer who produces a screenplay, and the producer or director wants a section rewritten, the task can be assigned to the writer who when the rewrite is completed can review and approve from the Bin. The round table also can track the progress of each member in the crew as well as the overall project progress.

A technology system program can be a Legal section with, e.g., templates for various contracts such as business agreements to share the rights and revenue to a project, Cast and Crew contracts, Releases for filming, confidentiality agreements, liability waivers, etc.

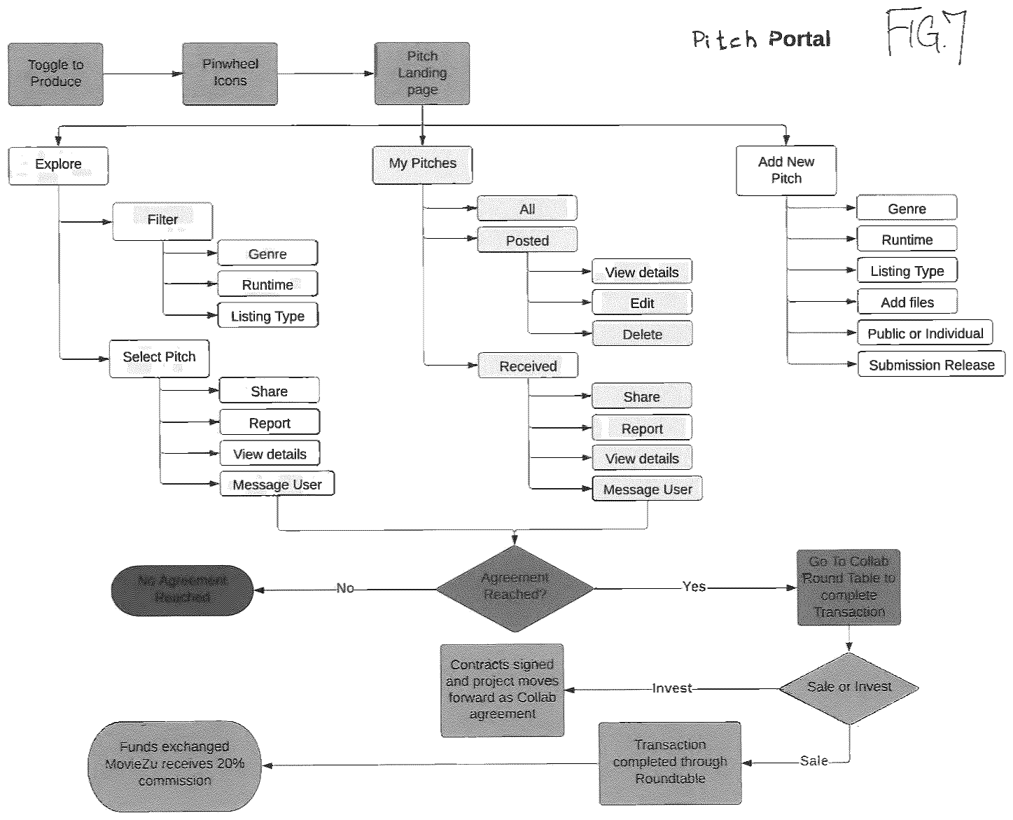

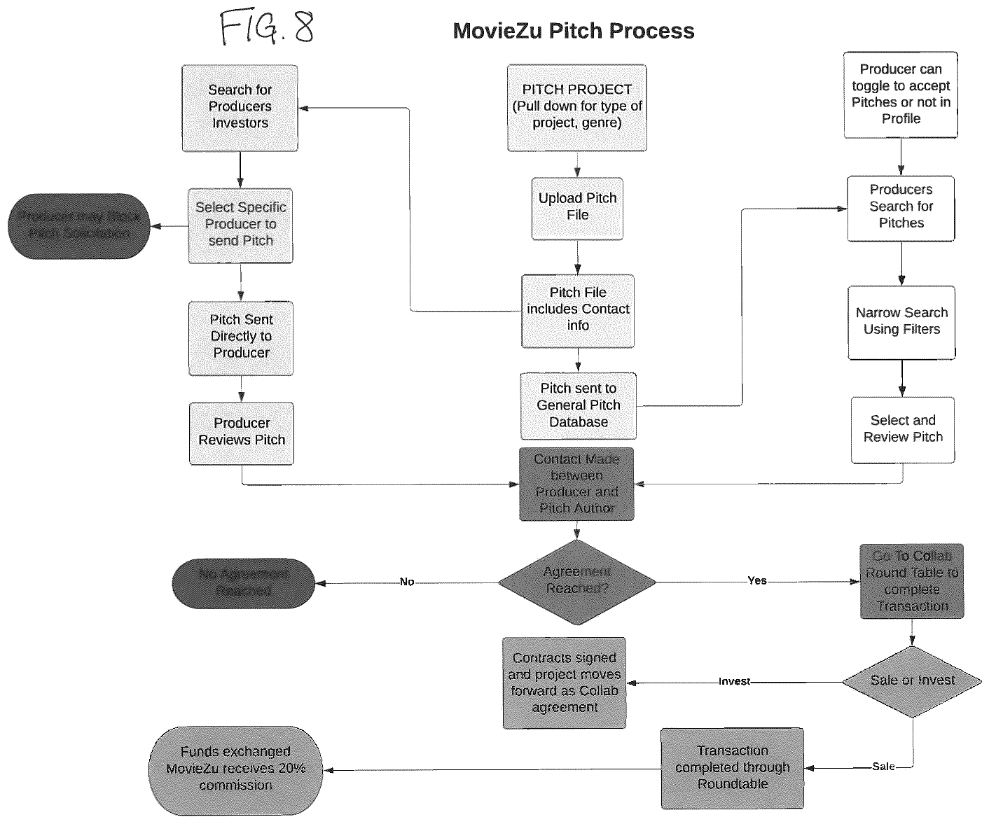

A technology system program can be a Pitch portal for people with ideas FIGS. 7-8.

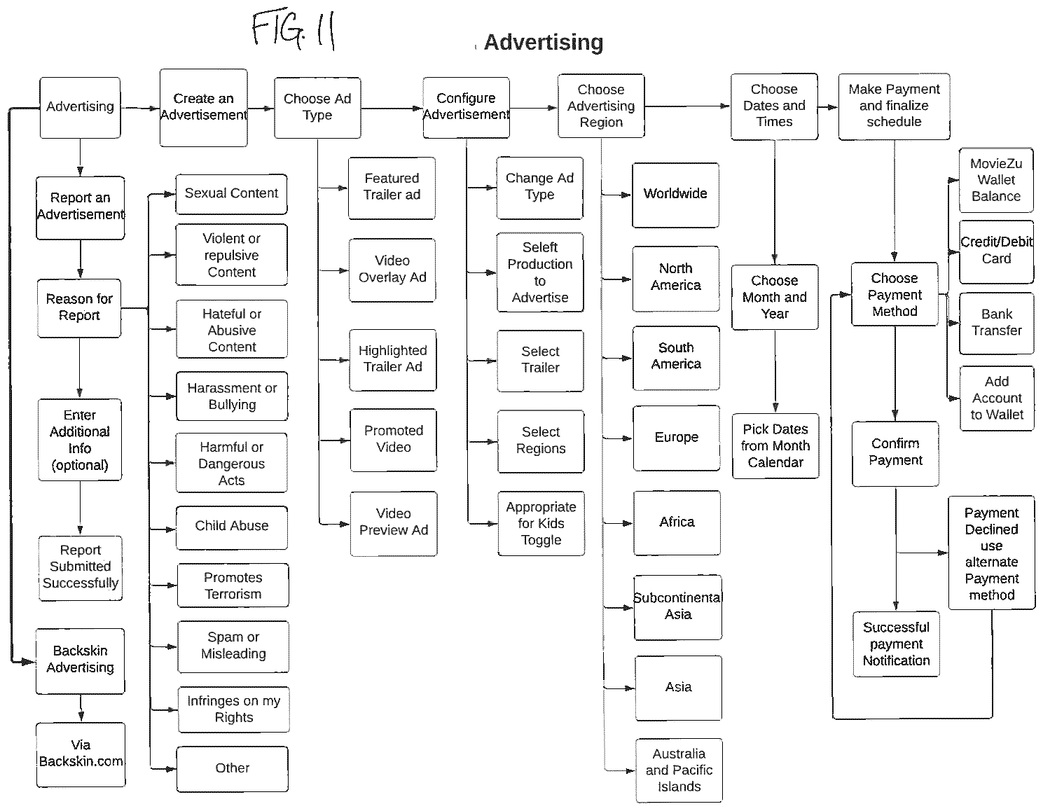

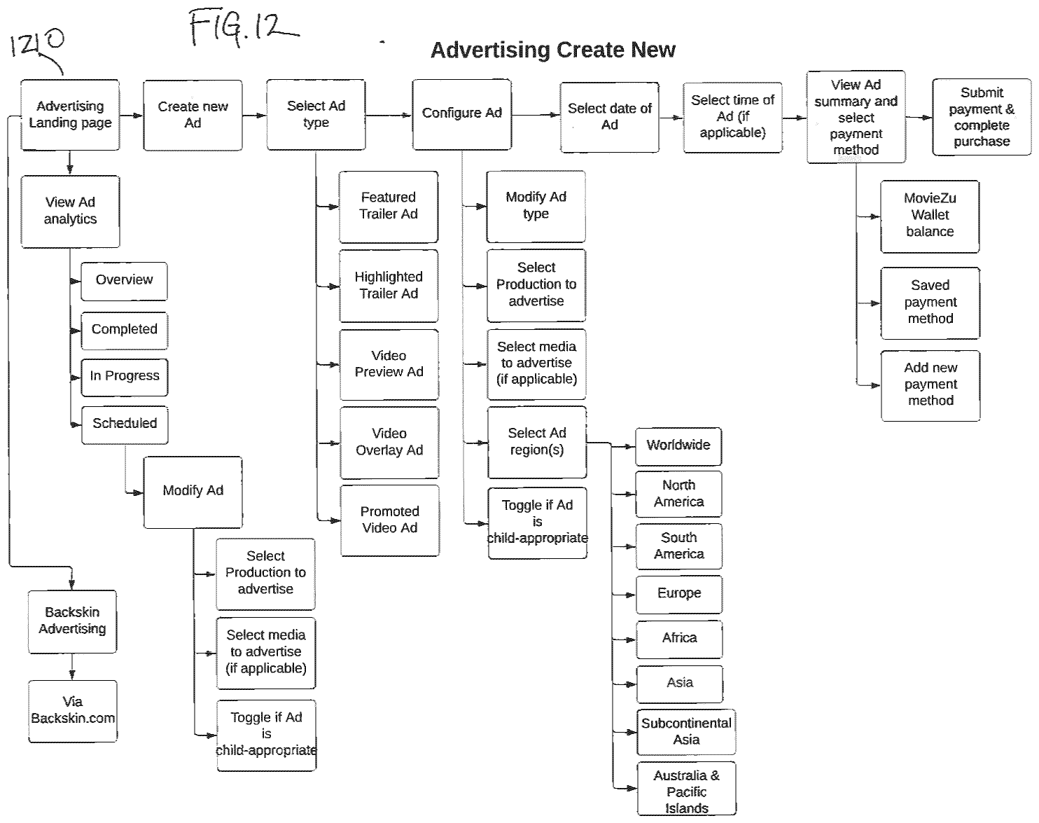

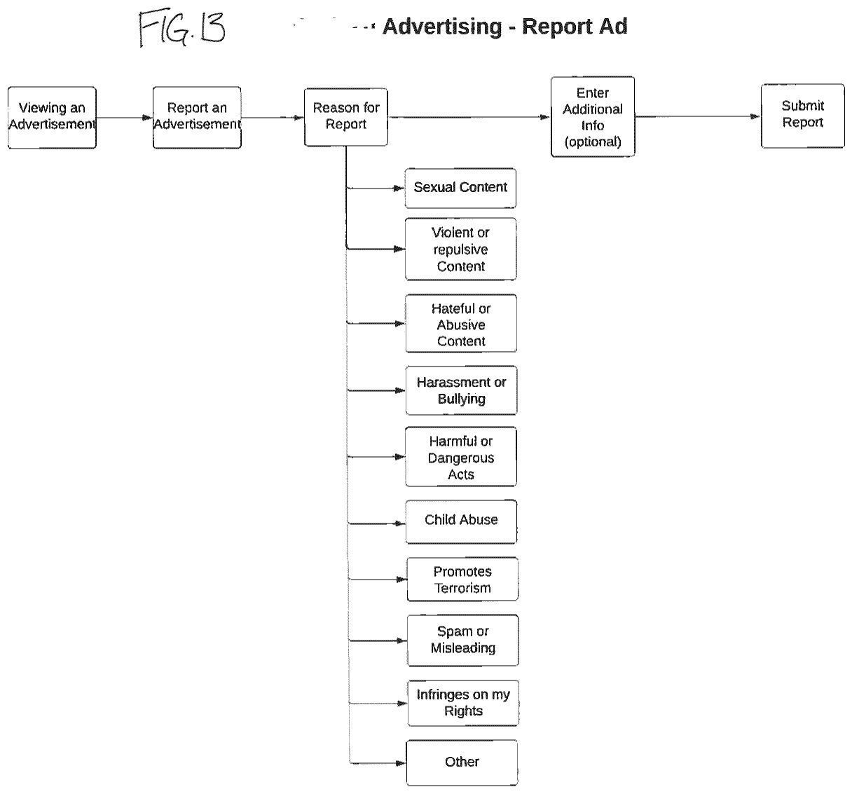

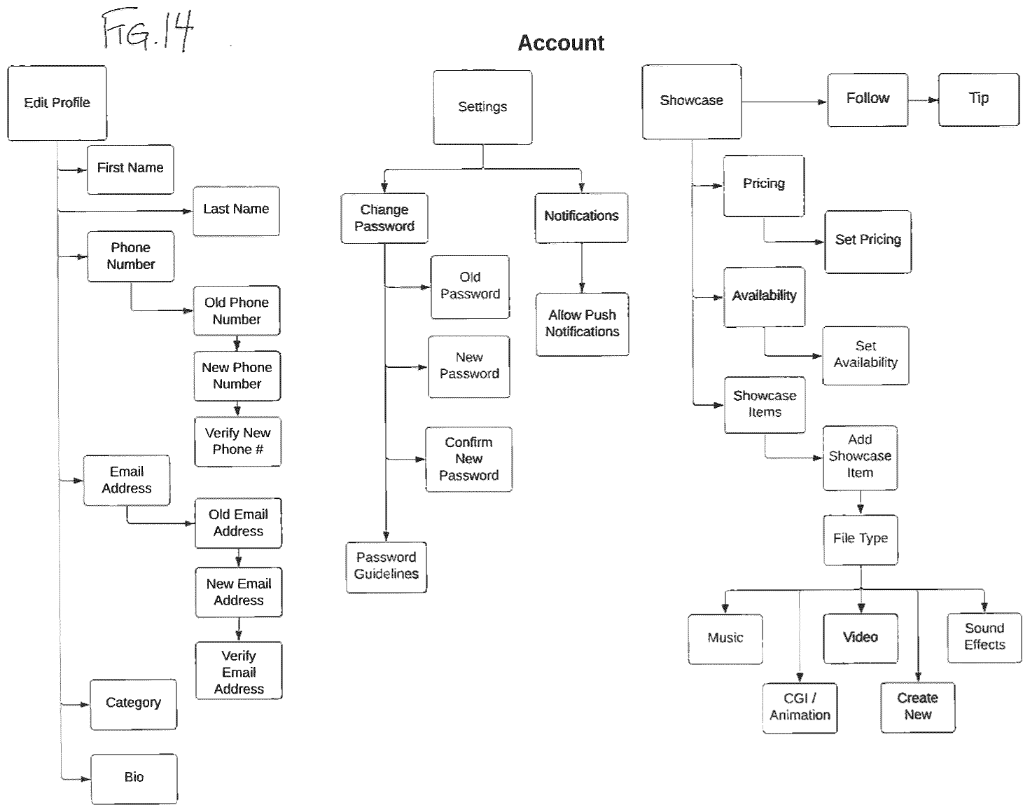

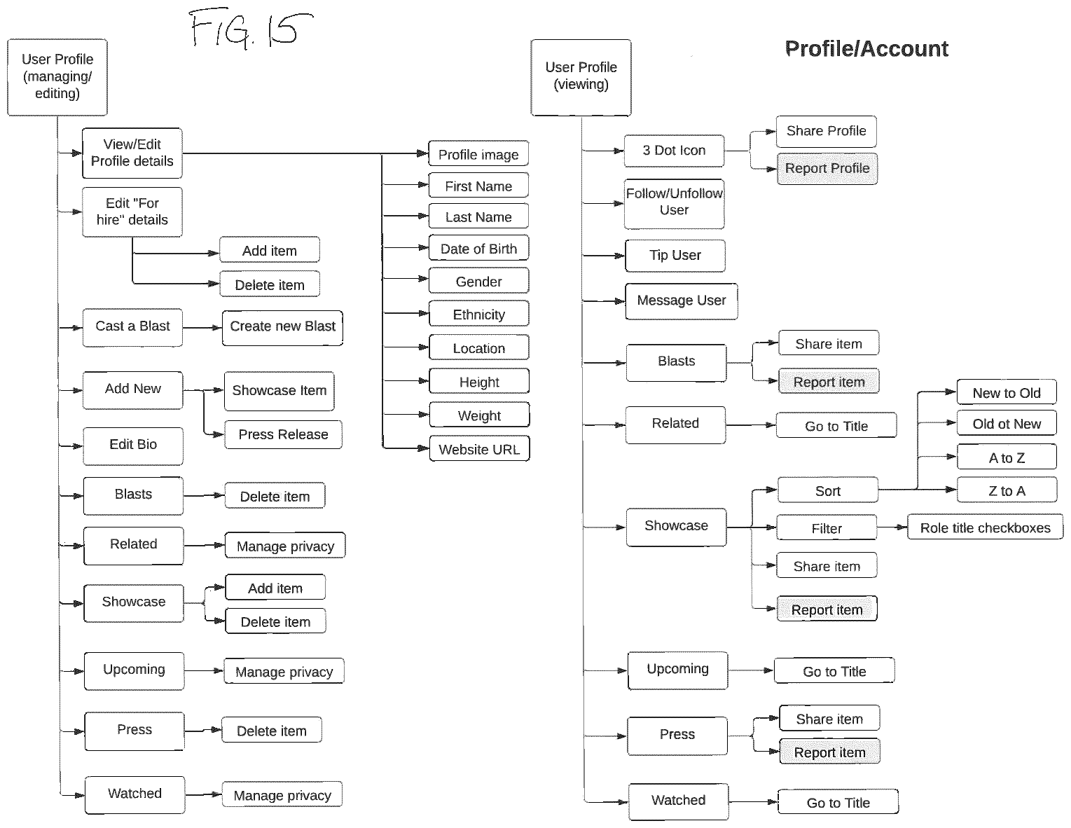

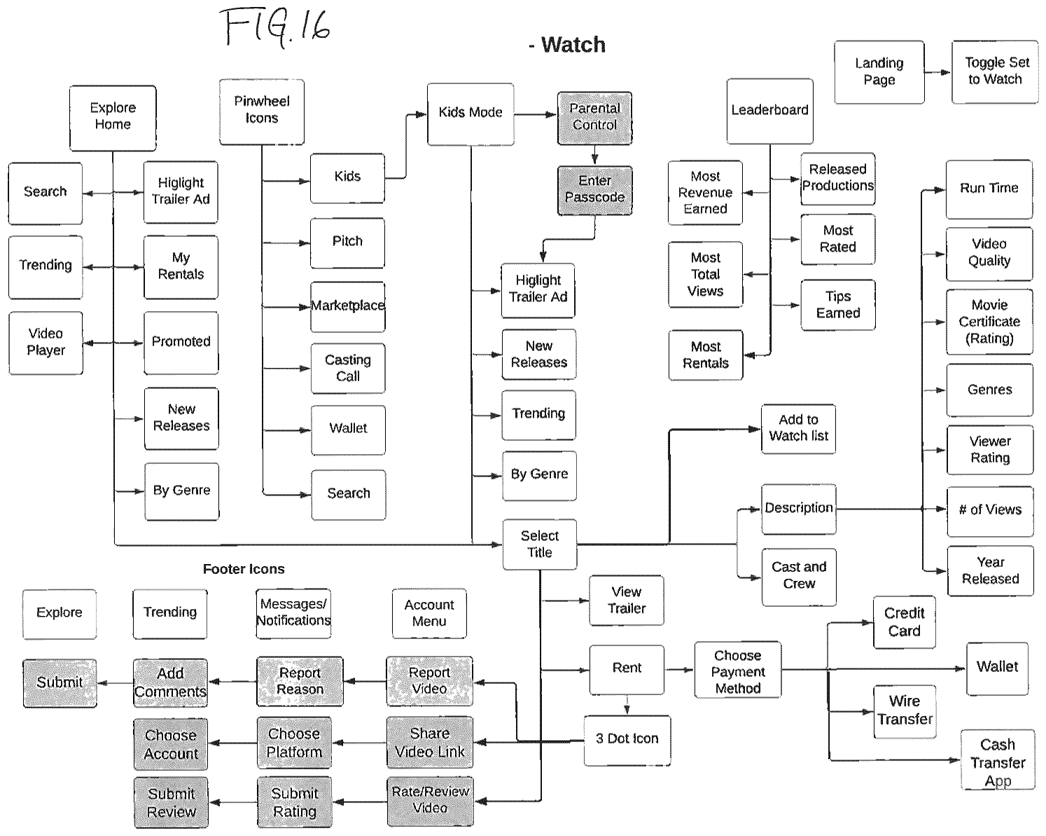

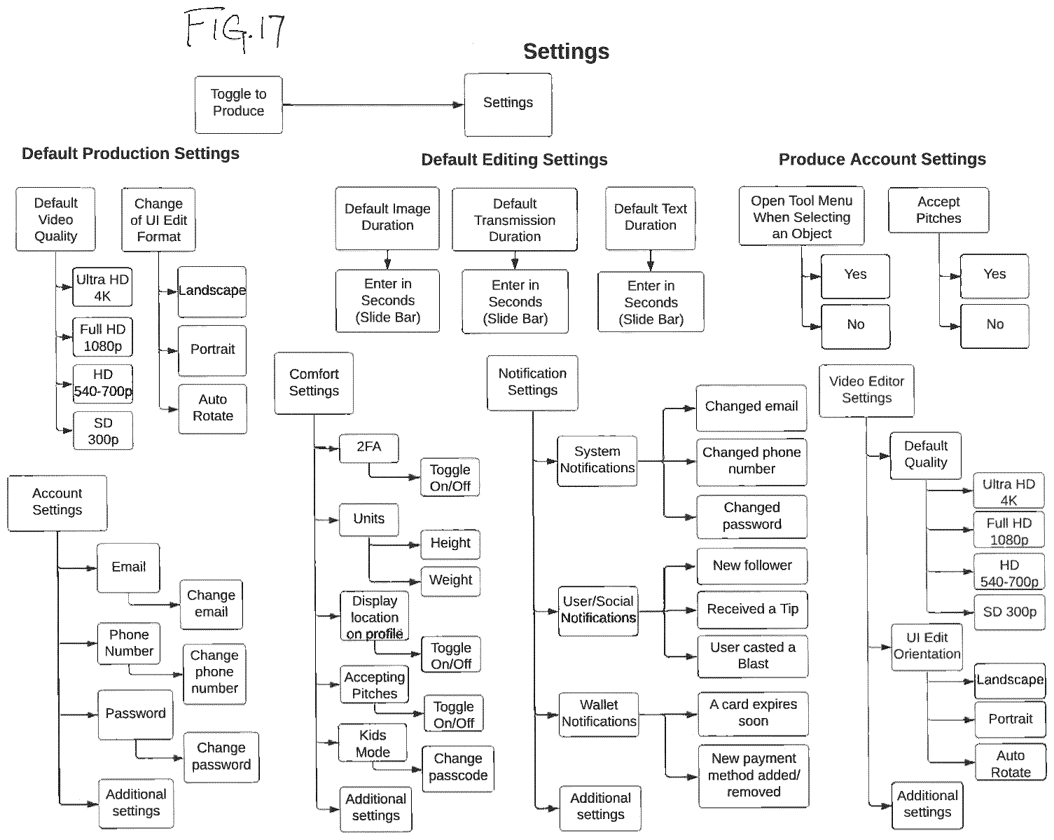

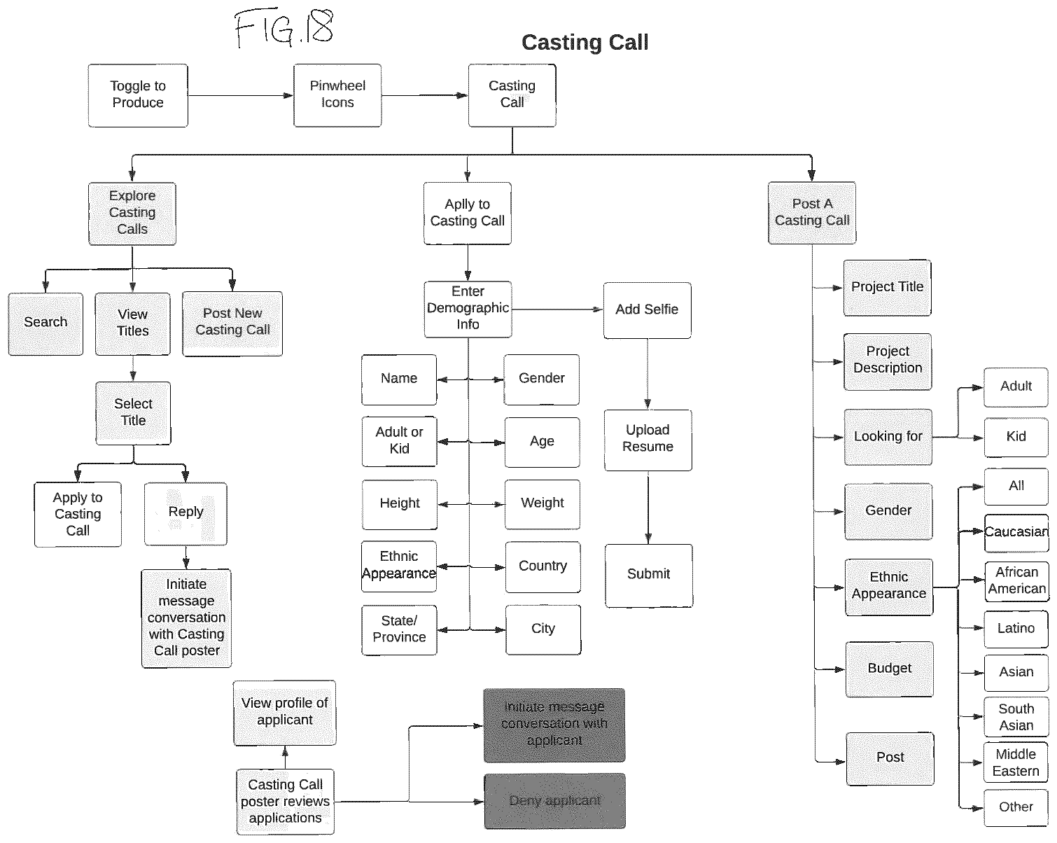

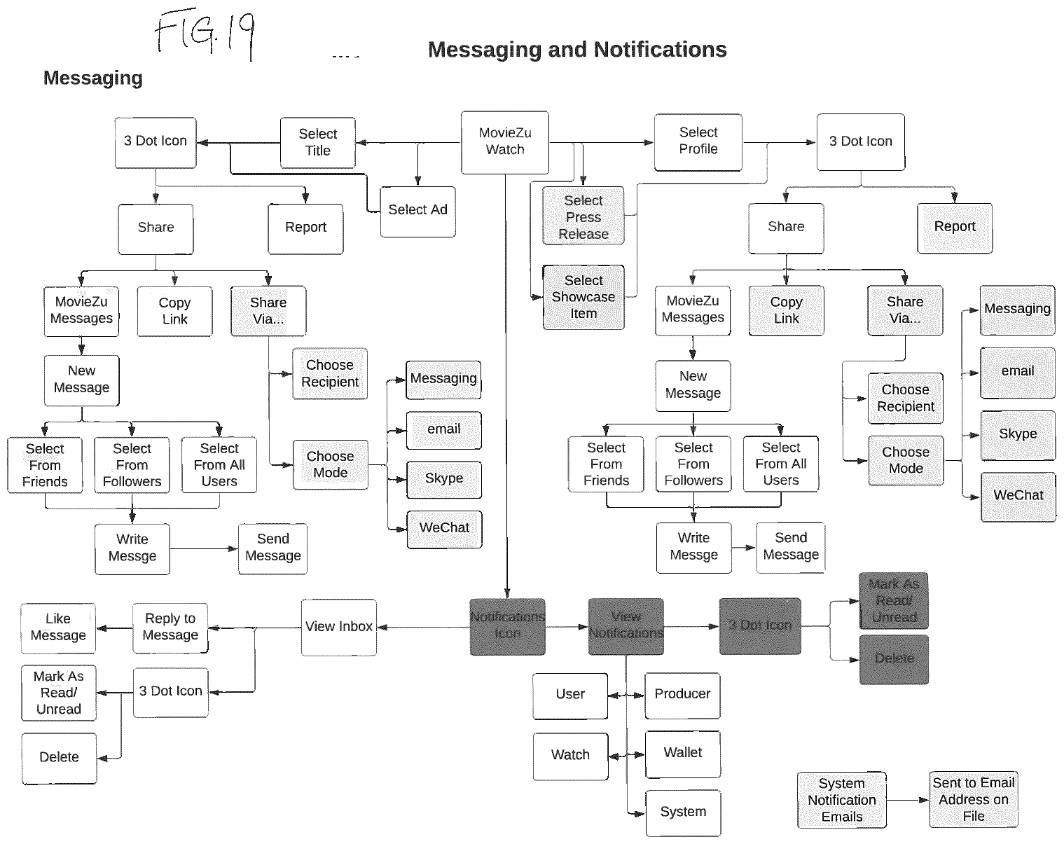

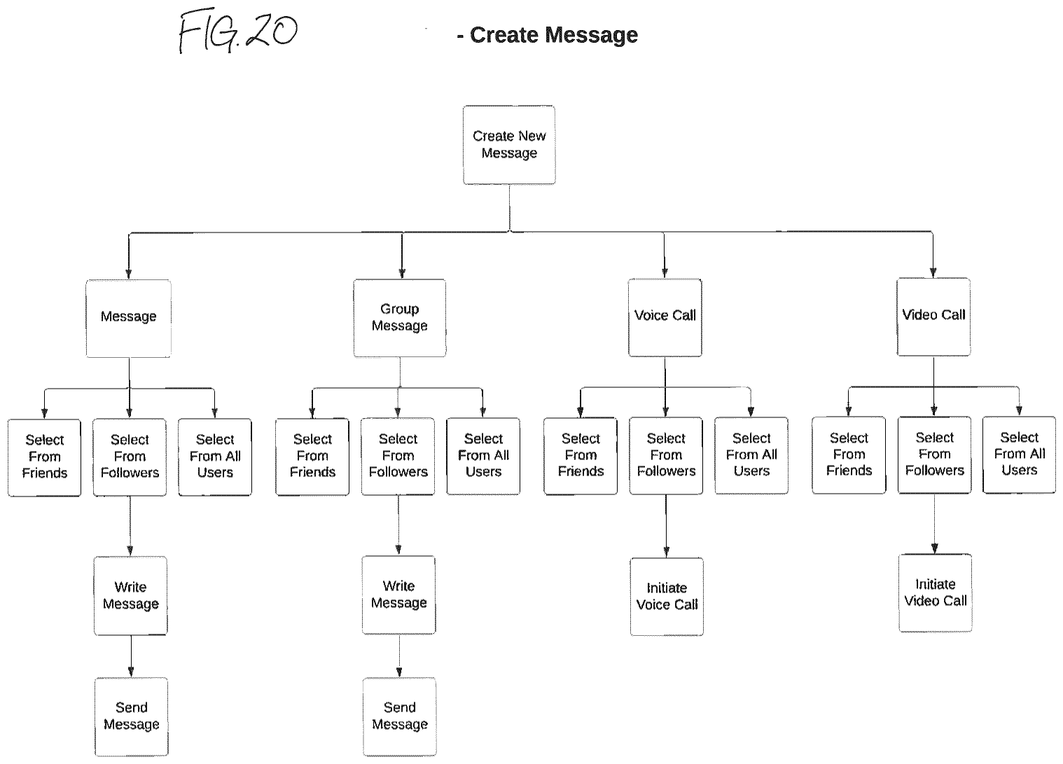

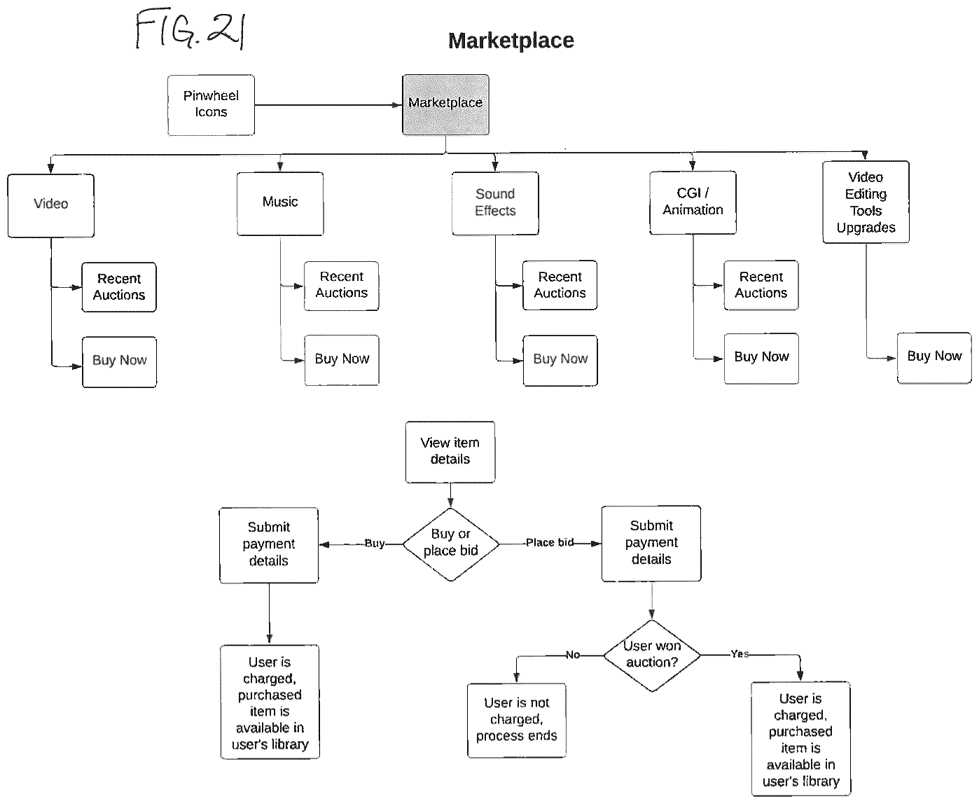

A system program for Marketing and Advertising, e.g., FIGS. 11-13 allows, e.g., a producer to purchase Advertising space on the technology. There can be provided four different Advertising Locations. These are:

Landing Page Trailers—Four 30 second Trailers that run in a continuous loop for an hour. These slots can be purchased for 1 hour or as many as can be budgeted for. Cost is per slot per hour.

Search Screen Featured Ads—Five 10 to 15 second slots rotating over an hour. The cost is per slot per hour.

Previews—These are Trailers of up to 60 second run time that air before the feature begins. Depending on the run time of the feature presentation, there can be a different number of available Preview slots. Feature Length Film >60 minute run time there can be Three 60 second previews; Series Length Features 30 to 60 minute run time can have Two 60 second previews; sitcom length feature 8 to 30 minute run time can have One 60 second preview. For Short Subjects 3 to 8 minute run time, there can be Two 20 second previews. All Previews costs are per day

Overlay Ads—These ads can air at the start of the Feature along the bottom of the screen and are designed for short advertisements of 10 to 20 seconds. The overlay ads can be limited in time, e.g. not exceed the first 3 minutes of the Feature so as to not take away from the viewer experience. The pricing for the Overlay Ads is based on the viewership of the feature. The number of available slots is based on the run time of the feature much like the previews.

E.g., Viewer-based pricing:
0-50,000 views price $3,500 per slot per day
50,001-250,000 views price $5,500 per slot per day
250,001-500,000 views price $9,500 per slot per day
500,001,1,000,000 views price $15,000 per slot per day
Over 1,000,000 views price $25,000 per slot per day

Available slots based on run time:
Feature Length 9×20 second slots
Series length 5×20 second slots
Sitcom length 3×20 second slots
Short Subject length 2×10 second slots

There are seven Geographic Regions available to choose from to advertise in order to reach the desired target market. The regions are as follows:
North America (US and Canada)
South America (Mexico, Central America and the Caribbean Islands included)
Europe
Africa
Subcontinental Asia (Middle East, India and surrounding nations)
Asia (including China, Japan, Korea, and Southeast Asian nations)
Australia (including New Zealand and the Pacific Islands)
Advertisers can choose one or all regions (global), pricing can be per region.

Advertising revenue generated from the Previews and Overlay Ads can be split 80/20.

All revenue from a film be it from sales or advertising and from the marketplace can be deposited in the producer's wallet. System program Accounting software can track all revenue and distribute to all partners in the project based on contract information stored in the system. The producer can track the progress and popularity of their work right on the app within the wallet showing number of views, total revenue from viewership and their share of the sales. Additionally, Advertising revenue is also tracked as well as viewership of the ads placed by the producer for each feature.

From a menu users can access the Profile, Wallet, Settings, Terms and Conditions, FAQ and navigate to other system programs. These can be suggested to the user based on user values, e.g. user had done sound after lighting in all previous sessions, therefore the system can suggest to the user the sound program after the user has ended a lighting program session. The technology would then suggest the appropriately valued sound programs for this user.

Many of the examples described herein are provided in the context of a social or business networking website or service. However, the applicability of the subject matter is not limited to a social or business networking service. A social networking service is an online service, platform or site that allows members to build or reflect social networks or social relations among members. Typically, members construct profiles, which may include personal information such as name, contact information, employment information, photographs, personal messages, status information, links to web-related content, blogs, and so on.

A method includes receiving, at a processor of a computing device, a first search query during creating or editing of a film, the first search query including at least a first search term. The method also includes identifying at least one style attribute associated with the search query and searching at least one database on a memory based on the first search term, the at least one style attribute, or a combination thereof, to generate search results. Each style attribute is associated with a value based on its characteristics, e.g. classical music that is fast, complicated, orchestrated, joyful, etc. The method further includes outputting the search results. A first search result of the search results is ranked higher than a second search result of the search results based on a determination that the first search result more closely matches the at least one style attribute associated with the design than the second search result.

Style attributes can be genre of music, musical instruments, genre of films, genre of games, actors, physical characteristics of humans, plants or other substances, images, or ideas. The values associated with the style attributes are based on the characteristics of the attributes. A more complicated, fully orchestrated, fast paced, and joyful piece of classical music can be valued based on those attributes. A different value will apply to a melancholy solo piano classical piece of music.

Methods and apparatus are presented for a search tool that provides a user interface through which a user may both display an image and perform an image similarity query based on the displayed image. The search tool may allow a user to repeat this process until a desired image is found and displayed. Further, the image repository to be searched may be specified by a user and the images to be modified and searched for may be any type of image. The search tool may be integrated within a merchant website, an image management system, or otherwise associated with the platform. Instead of an image this search tool may be applied to music, musical instruments, genre of films, genre of games, actors, physical characteristics of humans, plants or other substances, images, or ideas.

A method comprising determining a first set of high ranking skills, the first set containing skills possessed by a member of the social networking service based upon the member's user profile; determining a second set of high ranking skills, the second set containing skills for a second member of the social networking service based on the second member's user profile; determining a third set of high ranking skills, the third set being the intersection between the first and second set of high ranking skills; and suggesting to the first user a second user that has one or more of the skills in the third set of high ranking skills missing from the first user.

Methods and systems for authenticating users and assigning authenticated users values are provided. A method can include receiving a user credential and email address. The method forwards an authentication request including the email address and credential to a remote authentication provider. Based in part on the presence of a user name in a received response, the method determines that the user is authenticated. Another method extracts a domain name from a received email address of an authenticated user. In response to determining that the domain name is associated with a value, the method assigns the user that vale. A system includes memory with instructions for assigning an authenticated user a value. The values can be based on musical styles, film genres, actors, actor characteristics, or other criteria. These criteria can be derived from a user profile that can be created by a user or derived from a search of the users presence on searchable databases as input into an algorithm that assigns criteria based on known user characteristics, e.g. a user that subscribes to The Criterion Channel can be assigned a certain value. Users can have on or more values.

The method and system can scan social media postings and other content available regarding a user to determine specific film related interests, i.e. musical styles, film genres, actors, actor characteristics, or other interests. The system can automatically aggregate users into different groups that are either categorized by similarities or synergies. Similarities are the same or similar interests based on a predefined scale. Synergies are users that might need services or goods from other users.

The technology ranks media content items with respect to a particular user based on selection values determined for each of the media content items. The selection values may be determined using a particular model that calculates a predicted selection value based on feature values associated with the content item with respect to the particular user. The feature values may indicate properties of the media content item, the particular user, or the particular user's relationship with the content item, including information about the novelty of the media content item with respect to the user. The particular model may be trained with sample user consumption data points that represent various combinations of media content items and users. The data point information evaluated during the training of the particular model may cause the model to assign higher selection values to content items that are novel in particular ways.

In this manner, the intelligent automated assistant systems of various embodiments of the present invention can unify, simplify, and improve the user's experience with respect to many different applications and functions of an electronic device, and with respect to services that may be available over the technology.

As used in this application, “processor”, “component,” “module,” “system”, “interface”, “program” “memory”, or the like are generally intended to refer to a computer-related entity, either hardware, a combination of hardware and software, software, or software in execution, e.g., a component can be, but is not limited to being, a process running on a processor, a processor, an object, an executable, a thread of execution, a program, or a computer. By way of illustration, both an application running on a controller and the controller can be a component. One or more components can reside within a process or thread of execution and a component can be localized on one computer or distributed between two or more computers.

Unless specified otherwise, “first,” “second,” or the like are not intended to imply a temporal aspect, a spatial aspect, an ordering, etc. Rather, such terms are merely used as identifiers, names, etc. for features, elements, items, etc., e.g., a first object and a second object generally correspond to object A and object B or two different or two identical objects or the same object.

Moreover, “example” and “e.g.,” is used herein to mean serving as an example, instance, illustration, etc., and not necessarily as advantageous. As used herein, “user” can be a content creator, a content publisher, a viewer, an advertiser, a visitor, or any other role within the film, movie, television, or other motion picture industry. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

We claim:

1. A computing device, comprising:
one or more processors;
one or memories; and
one or more programs, wherein the one or more programs are stored in the memory and configured to be executed by the one or more processors, the one or more programs including instructions for:
receiving, within a communication session between a user and a system program, a user request for the system program to facilitate use of an industry function using an industry program;
in response to receiving the user request for the system program to facilitate the use of the industry function using an industry program, determining one or more user values based on role, expertise, abilities, user's input, user's past use, or other users' feedback;
in response to receiving the user request for the system program to facilitate the use of the industry function using an industry program, facilitating the use of the industry function using an industry program by:
identifying one or more industry programs that provides the industry function requested by the user;
determining one or more values for the one or more identified industry programs;
matching the best valued industry programs with the user by choosing the closet values for each of the users and industry programs;
transmitting the industry program to the user; and
receiving a response from the user indicating whether the matching was successful;
providing, in the communication session, an output corresponding to the received response.

2. A method of using a computing device comprising one or more processors, one or memories, and one or more programs, comprising:
receiving at a processor, a first user search query during a communication session, the first user search query including at least a first search term;
identifying at least one style attribute associated with the search query and searching at least one database on a memory based on the first search term, the at least one style attribute, or a combination thereof;
generating search results wherein, a first search result of the search results is ranked higher than a second search result of the search results based on a determination of user's values associated with the user, search result values for the search results, and style attribute values associated with the style attribute; and
transmitting the search results to the user.

3. A method of using a computing device comprising one or more processors, one or memories, and one or more system programs, comprising:
determining a first set of high ranking skills, the first set containing skills possessed by a first user of the one or more system programs based upon the user's profile;
determining a second set of high ranking skills, the second set containing skills for a second user of the one or more system programs based on the second member's user profile;
determining a third set of high ranking skills, the third set being the intersection between the first and second set of high ranking skills; and
suggesting one or more second users to the first user based on the third set of high ranking skills.
